(19) United States
(12) Patent Application Publication
(10) Pub. No.: US 2010/0169370 A1
(43) Pub. Date: Jul. 1, 2010

(54) Kstore event manager using triggers for K

(76) Inventors: Jane C. Mazzagatti, Blue Bell, PA (US); Tony Phan, Abington, PA (US)

Correspondence Address: UNISYS CORPORATION, UNISYS WAY, MAIL STATION: E8-114, BLUE BELL, PA, 19424, US

(21) Appl. No.: 12/317,979

(22) Filed: Dec. 31, 2008

(51) Int. Cl. G06F 7/00; G06F 9/54; G06F 17/30

(52) U.S. Cl. 707/774; 719/318; 707/E17.044; 719/328

(57) ABSTRACT

The KStore or K is a datastore made up of a forest of interconnected, highly unconventional trees of one or more levels. A KStore event manager monitors events and polls for KStore state. When triggered by user-defined conditions or receiving notification that a specified event has occurred, a specified response can be executed. An event/condition/response is defined through a KStore event wizard. When a triggering condition is detected or a notification of an event is received, a user-defined action or sequence of actions is performed automatically, without further user interaction.

### RELATED APPLICATIONS

This application claims the benefit of U.S. patent application Ser. No. 11/084,996, filed Mar. 18, 2005, entitled “SYSTEM AND METHOD FOR STORING AND ACCESSING DATA IN AN INTERLOCKING TREES DATASTORE” by MAZZAGATTI et al. which application is a Continuation of U.S. patent application Ser. No. 10/385,421, filed Mar. 10, 2003 and U.S. patent application Ser. No. 11/185,620, filed Jul. 20, 2005, entitled “METHOD FOR PROCESSING NEW SEQUENCES BEING RECORDED INTO AN INTERLOCKING TREES DATASTORE,” by MAZZAGATTI. These applications are incorporated in their entirety herein.

### TECHNICAL FIELD

The present disclosure relates to data processing systems, and datastores to such systems. In particular, the present disclosure relates to an event manager relating to data nodes within an interlocking trees datastore.

### BACKGROUND

Data structures facilitate the organization and referencing of data. Many different types of data structures are known in the art, including linked lists, stacks, trees, arrays and others. The tree is a widely-used hierarchical data structure of linked nodes. The conventional tree is an acyclic connected graph where each node has a set of zero or more child nodes and at most one parent node. A tree data structure, unlike its natural namesake, grows down instead of up, so that by convention, a child node is typically referred to as existing “below” its parent. A node that has a child is called the child's parent node (or ancestor node, or superior node). In a conventional tree, a node has at most one parent. The topmost node in a tree is called the root node. A conventional tree has at most one topmost root node. Being the topmost node, the root node does not have a parent. Operations performed on the tree commonly begin at the root node. All other nodes in the tree can be reached from the root node by following links between the nodes. Nodes at the bottommost level of the tree are called leaf nodes or terminal nodes. As a leaf node is at the bottommost level, a leaf node does not have any children.

### SUMMARY

The KStore or K is a datastore made up of a forest of interconnected, highly unconventional trees of one or more levels. Each node in the KStore can have many parent nodes. The KStore is capable of handling very large amounts of highly accessible data without indexing or creation of tables. Aspects of KStore are the subject of a number of patents including U.S. Pat. Nos. 6,961,733, 7,158,975, 7,213,041, 7,340,471, 7,348,980, 7,389,301, 7,409,389, 7,418,455 and 7,424,480, which are hereby incorporated by reference in their entirety.

The KStore Event Manager may collect user input via a user interface (e.g., a GUI or graphical user interface) or the KStore Event Manager may run a background job that collects user input (e.g., parameters) from a user, from an application or from an existing well-defined set of user input. User input may define an internal KStore event or events, and a response or responses to the event or events. The user-defined KStore event(s) and/or response(s) may be actions that occur within the KStore. The user-defined response(s) may be actions that occur outside the KStore. The KStore Event Manager may monitor internal KStore events via the KStore API Utility. That is, the KStore Event Manager may direct the KStore API Utility to have the K Engine notify the KStore Event Manager when a particular internal KStore event(s) occur(s). Upon receiving the notification, the KStore Event Manager may perform the response(s). For example, the KStore Event Manager may use the KStore API interface to direct the K Engine to create an event to notify the KStore Event Manager when the K Engine creates new structure in the KStore. When the KStore Event Manager receives the notification from the K Engine that new KStore structure has been created, the KStore Event Manager may perform the response(s) as directed by the user.

User input, however collected, may define a condition (state) or conditions of the KStore and specify the desired response(s) thereto. User input may specify an interval at which the KStore is polled for the user-specified condition(s). The KStore Event Manager may use the KStore API utility to direct a polling application to perform the polling of the KStore in accordance with the user-specified polling interval. Upon detection of the condition(s) the KStore Event Manager may execute the user-specified response. The Event Manager may, for example, set up an analytic to be run periodically according to a user-defined polling interval. Once a triggering condition is detected, the user-defined response comprising an action, event or sequence of actions or events is performed automatically, without further user interaction.

### BRIEF DESCRIPTION OF THE DRAWINGS

In the drawings:

FIG. 1 is a block diagram illustrating an example of an interlocking trees datastore (KStore or K) in accordance with aspects of the subject matter disclosed herein;

FIG. 2 is an example of a dataset from which the KStore of FIG. 1 was generated in accordance with aspects of the subject matter disclosed herein;

FIG. 3 is a block diagram illustrating an example of a node structure of a node of an interlocking trees datastore (KStore or K) in accordance with aspects of the subject matter disclosed herein;

FIG. 4 illustrates an example of levels of a KStore in accordance with aspects of the subject matter disclosed herein;

FIG. 5 illustrates an example of a system environment in which aspects of the subject matter disclosed herein can be practiced.

FIG. 6 is a block diagram of a system in accordance with aspects of the subject matter disclosed herein; and

FIG. 7 is a flow diagram of a method for monitoring KStore events and conditions based on user input in accordance with aspects of the subject matter disclosed herein.

### DETAILED DESCRIPTION

### Overview of KStore Data Structure

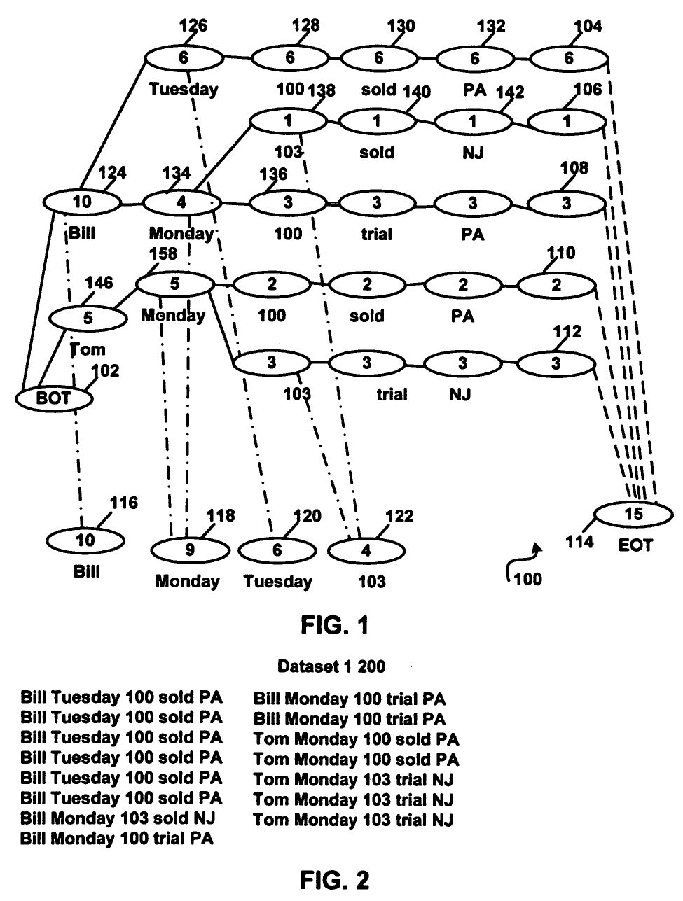

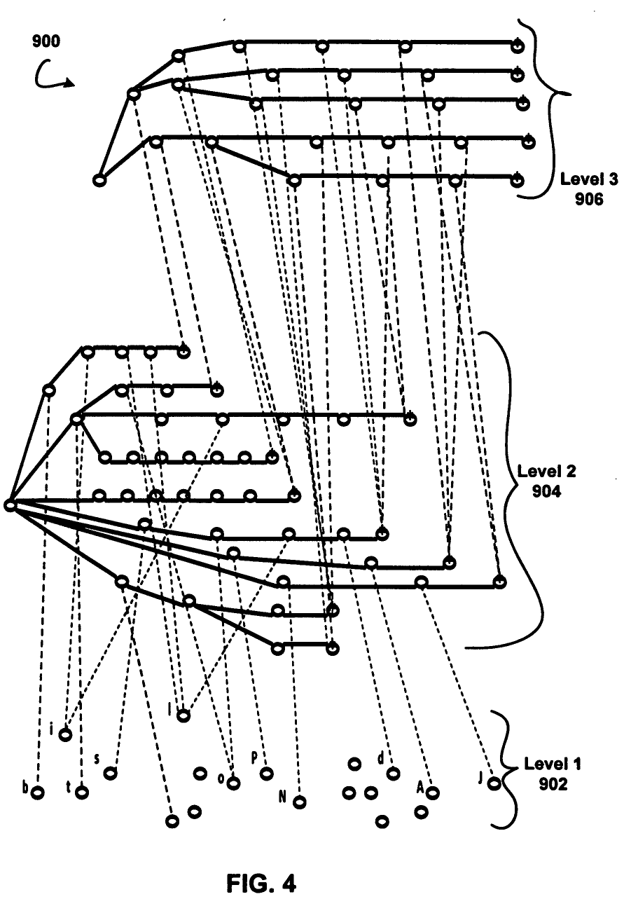

A KStore or K is a datastore made up of a forest of interconnected trees. FIG. 4 illustrates a multi-level KStore structure 900 created from the data in Dataset 1 200 of FIG. 2. The highest level (level 3) 906 of the KStore 900 represents the KStore 100 illustrated in FIG. 1 and represents records (e.g., Tom-Monday-103-trial-NJ). The middle level (level 2) 904 represents the field content or variables (the root nodes of KStore 100) which make up the records of level 3 906 (e.g., the variable Tom, the variable Tuesday, etc.) and the lowest level (level 1) 902 represents the universe of dataset elements that are combined to make up the variables (e.g., the letter T, the letter o, the number 1, the number 0 and so on). It will be appreciated that multi-level KStores of any number of levels can exist. Additional levels can be added or removed at any time, and existing levels can be updated at any time. For example, an additional level (level 4, not shown) representing datasets (of which Dataset 1 200 of FIG. 2 is one dataset) can be added above level 3 906. Additional records can be added to level 3 906. Additional variables can be added to level 2 904. Additional dataset elements (e.g., the letter v) can be added to level 1 902. Moreover, updates to one level of the KStore are propagated to other levels as required. For example, the addition of a record for Violet-Tuesday-100-sold-NY, would be reflected in all the levels of the KStore. The record would be added to level 3 906, the variables of level 2 904 would be updated to include the new variables Violet and NY and the list of elemental root nodes of the lowest level, level 902 of FIG. 9 would be updated to include elemental root nodes for V and Y.

The interlocking trees datastore comprises a first tree that depends from a first root node (a primary root node) and may include a plurality of branches. Each of the branches of the first tree ends in a leaf node called an end product node. The first root node may represent a concept, such as but not limited to a level begin indicator (e.g., BOT or Beginning of Thought). For example, referring to FIG. 1, KStore 100 includes a first tree depending from a first root node 102 and including 5 branches (e.g. the topmost branch is comprised of nodes 102, 124, 126, 128, 130, 132 ending with the leaf node 104.

A second root (e.g., root node 114) of the same level of the same trees-based datastore is linked to each leaf node of the first tree (e.g., to nodes 104, 106, 108, 110 and 112) and is called an EOT (End Of Thought) node. Leaf nodes of a KStore are also called end product nodes. End product nodes include a count that reflects the number of times the sequence of nodes from BOT to EOT has occurred for the unique sequence of nodes that end with that particular end product node. For example, node 106 with a count of 1 reflects the counts associated with the path connecting nodes 102, 124, 134, 138, 140 and 142. The second root (e.g., root node 114) is a root to an inverted order of the first tree or to an inverted order of some subset of the first tree, but does not duplicate the first tree. Node 134 is a node that is shared by the KStore path that ends with end product node 106 and by the KStore path that ends with end product node 108. Thus the count of node 134 (4) is the combination of the count of node 106 (1) and the count of node 108 (3).

Finally, the trees-based datastore comprises a plurality of trees of a third type in which the root node of each of these trees can be described as an end product node of an immediately adjacent lower level or as an elemental root node and may include or point to data such as a dataset element or a representation of a dataset element. The root nodes 116, 118, 120 and 122 are end product nodes of the immediately adjacent lower level of the KStore. It will be appreciated that not all of the root nodes of KStore 100 are illustrated in FIG. 1 to avoid unduly cluttering the Figure. The root node of each of these trees may be linked to one or more nodes in one or more branches of the unduplicated first tree. The nodes of the trees-based datastore may contain pointers to other nodes in the trees-based datastore instead of data per se, and may also contain additional fields. One such additional field may be a count field (e.g., the count field of node 120 is 6 and the count field of node 108 is 3). Multiple levels of the above-described tree-based datastore may be generated and accessed, the end products of the lower level becoming the root nodes of the next level.

FIG. 1 represents KStore 100, a portion of a KStore generated from Dataset 1 200 illustrated in FIG. 2. For example, Dataset 1 200 includes a set of six instances of the record Bill Tuesday 100 sold PA. Hence the count for the nodes 126 (Tuesday), 128 (100), 130 (sold), 132 (PA) and node 104 (a count of the number of the Bill Tuesday 100 sold PA records) are all 6. Similarly, there is only one record for Bill Tuesday 100 sold PA thus the counts for nodes 138 (100), 140 (sold), 142 (NJ) and 106 are all 1. The count for node 124 (Bill) is 10 because there are 10 records in Dataset 1 that have Bill in the first field of the record. Similarly the count of node 146 (Tom) is 5 because there are 5 records in Dataset 1 that have Tom in the first field of the record.

Branches of the first tree are called asCase branches or asCase paths. AsCase paths are linked via asCase links denoted by solid lines in the Figures. Together, all the asCase paths of a KStore form the asCase tree of that level. The asCase tree depends from a first root (the primary root, e.g., node 102 in FIG. 1). Multiple asResult branches or asResult paths form multiple asResult trees that depend from respective, multiple roots. AsResult paths are linked via asResult links denoted by dashed lines: (-.-.- and - - - in FIG. 1 and - - - in FIG. 9). For example, in FIG. 1 a number of asResult trees are illustrated including the asResult tree comprised of root node 116 representing the dataset element Bill and internal node 124 having a count field of 10 (ten) representing that 10 records of the dataset that resulted in the creation of the KStore of FIG. 1 had a value of Bill in a particular field. Another asResult tree illustrated in FIG. 1 is the asResult tree comprised of the following nodes: root node 118 representing the dataset element Monday, which is linked by asResult links to node 134 and to node 158. The count of root node 118 is 9, the sum of the counts of node 134 (4) and node 158 (5). The count 9 indicates that 9 records of the dataset that resulted in the creation of the KStore of FIG. 1 had a value of Monday in a particular field. One instance of an asResult tree comprises the asResult tree whose root node is node 114. This root node, node 114 in FIG. 1, is linked to each end product node (e.g., nodes 104, 106, 108, 110 and 112). This asResult tree can access the branches of the asCase tree terminating in end products in inverted order. This asResult tree can also be used to define root nodes for the next level. These root nodes may represent dataset elements for the next adjacent level, composed of the set of end products of the lower adjacent level.

The interlocking trees datastore may capture information about relationships between dataset elements encountered in an input file by combining a node that represents a level begin indicator (e.g., BOT) with a node that represents a dataset element to form a node representing a subcomponent. A subcomponent node may be combined with a node representing a dataset element to generate another subcomponent node in an iterative sub-process. Combining a subcomponent node with a node representing a level end indicator may create a level end product node. The process of combining a level begin node with a dataset element node to create a subcomponent and combining a subcomponent with a dataset element node and so on may itself be iterated to generate multiple asCase branches in a level. AsResult trees may also be linked or connected to nodes in the asCase tree, such as, for example, by a root node of an asResult tree pointing to one or more nodes in the asCase tree.

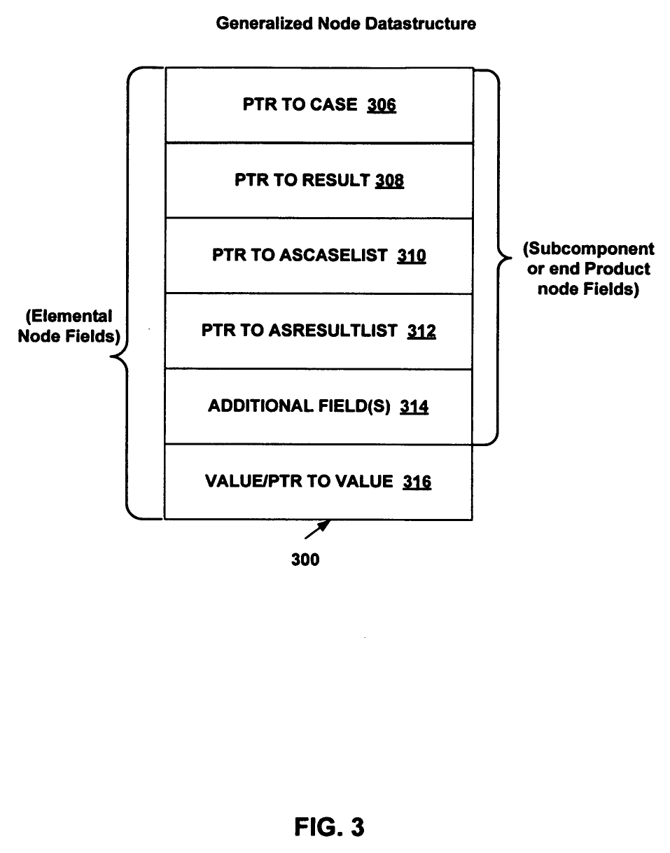

FIG. 3 illustrates the data fields of a typical node, e.g., node 300 of the interlocking trees data structure. Node 300 can represent an elemental root node, subcomponent node or end product node. When a new node is built in an interlocking datastore, memory is allocated for the new node as shown in FIG. 3. A plurality of pointers can then be stored in the allocated memory. The new node is defined by setting the asCase pointer (pointer to Case) 306 to point to the previous node in the path and setting the asResult pointer (pointer to Result) 308 to point to the root node. Thus, for example, if node 300 represents the subcomponent node 124 of the interlocking trees datastore shown in FIG. 1, the asCase pointer 306 would point to the BOT node, node 102 and the asResult pointer 308 would point to the Bill root node, node 116. The pointer to asCaseList 310 is a pointer to a list of the subcomponent nodes or end product nodes for which the node represented by the node 300 is the asCase node. For example, the asCaseList for node 134 would include pointers to nodes 136 and 138. It will be appreciated that the pointer to asCaseList, field 310 will be null for the elemental nodes and for end product nodes. The pointer to asResultList 312 is a pointer to a list of the subcomponents nodes or end product nodes for which the node represented by the exemplary node 300 is the asResult node. For example, the asResultList for node 124 would be empty. It will be appreciated that the pointer to asResultList field 312 will be null for all subcomponent nodes. The asResultList of root node 118 (Monday) includes pointers to nodes 158 and 134 tree. The nodes of the interlocking trees datastore can also include one or more additional fields 314. The additional fields 314 may be used for an intensity or count associated with the node. A count may be incremented or decremented to record the number of times that a node has been accessed or traversed or to record the number of times it was encountered or received in an input dataset. The additional fields 314 may be used for a list of all the elemental root nodes represented by the node or for any number of different items associated with the structure. Another example of a parameter that can be stored in an additional field 316 is the particle value representing a dataset element for an elemental root node. If the node is an elemental root node it may also contain a field 316, comprising the value of the dataset element it represents or a pointer to the value of the dataset element it represents.

As nodes are created, asCase and asResult links may be simultaneously generated at each level and asCaseLists and asResultLists may be generated and updated. As described above, an asCase link represents a link to the first of the two nodes from which a node is created. For example, referring to FIG. 1, the asCase link of node 124 points to node BOT 102. It will be appreciated that asCase branches of the asCase trees may be created by generation of the asCase links as the input is processed. The asCase branches of each level thus provide a direct record of how each subcomponent and end product of the level was created. Hence the asCase branches can be used to represent one possible hierarchical relationship of nodes in the asCase tree. For example if the data received by an interlocking trees generator is data concerning salesmen who sell products identified by product numbers in states of the United States, a particular input dataset may include the two records:

| | | | |
|---|---|---|---|
| Tom | sold | 100 | PA |
| Bill | sold | 40 | NJ |

where Tom and Bill are salesmen, 100 and 40 are product numbers and PA and NJ are states in which the salesmen sold their products. The asCase tree generated from this input may comprise a view of the data in the context of “state information with the context of salesman” context.

An asResult link represents a link to the second of the two nodes from which a node is created. For example, the asResult link of node 124 points to node 116 (Bill). The generation of the asResult links creates a series of interlocking trees where each of the asResult trees depend from a root comprising a dataset element. This has the result of recording all encountered relationships between the root nodes and the nodes of the asCase trees in the KStore. That is, the asResult trees capture all the possible contexts of the nodes of the interlocking trees. If, for example, the input to the interlocking trees datastore generator comprises a universe of sales data including salesman name, day of the week, product number and state, the resulting asResult links of the generated interlocking trees datastore could be used to extract information such as: “What salesmen sell in state X”, “How many items were sold on Monday?” “How many items did Salesman Bill sell on Monday and Tuesday?” and the like, all from the same interlocking trees datastore, without creating multiple copies of the datastore, and without creating indexes or tables.

It will be appreciated that this information is determinable from the structure of the interlocking trees datastore itself rather than from information explicitly stored in the nodes of the structure. Paths can be traversed backwards towards the root node to determine if the subcomponent or end product belongs to a particular category or class of data. Links between nodes may be bi-directional. For example, a root node for the dataset element “Monday” (e.g. root node 118) may include a pointer to a subcomponent BOT-Bill-Monday (e.g., node 134) in node 118's asResultList while the node BOT-Bill-Monday, node 134 may include a pointer to the node Monday, node 118, as its asResult pointer and so on. Furthermore, by following asCase links of the nodes containing a desired dataset element, other subcomponents and end products containing the desired dataset element can be found along the branch of the asCase tree. It will be appreciated that the described features cause the datastore to be self-organizing.

### KStore Triggers

The KStore Event Manager may use the KStore API utility to monitor two types of events occurring within the KStore data structure. The first type of events are events internal to the KStore. The KStore Event Manager may direct the KStore API Utility to have the K Engine notify the KStore Event Manager when a particular internal KStore event(s) occur(s). Upon receiving the notification, the KStore Event Manager may perform the response(s). For example, the KStore Event Manager can use the API utility described below to direct the K Engine to notify the KStore Event Manager when the K Engine creates new structure. Once this type of event is set up, whenever the event takes place within the KStore, the KStore Event Manager will be notified automatically. Once the KStore Event Manager receives the notification it can process the information provided in whatever way the user has defined using the KStore Event Manager. The KStore Event Manager may notify the user, or process an input verification routine, or perform any response to the event occurring that the user has specified in the GUI or wizard or via the background KStore Event Manager feature.

The KStore Event Manager can also manage events occurring in the KStore that have external meaning to the user. That is, the KStore Event Manager can manage the periodic polling for a user-specified condition (state) or conditions of the KStore. The KStore Event Manager may use the KStore API utility to direct a polling application to perform the polling of the KStore in accordance with the user-specified polling interval. When the specified condition is attained, the user-specified response(s) are performed. For example, an analytic such as single variable prediction may be used to determine the current probability of a variable. The analytic may be run periodically in a polling fashion. When the probability of the variable becomes equal to some user-specified value, the Event Manager may process that information in accordance with the user's input. described herein uses analytics to match patterns and check thresholds so that particular specified actions can be performed when triggered by user-defined conditions and events. An event is defined and conditions are specified using a KStore API. When an event is defined using the API, conditions associated with that event are identified. When the conditions occur, a user-specified action or sequence of actions occur automatically.

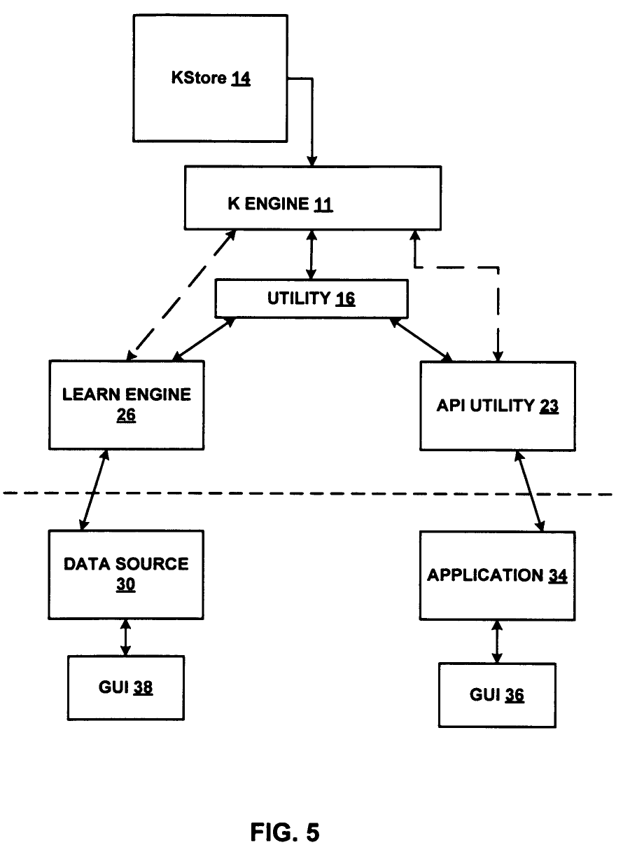

FIG. 5 illustrates an example of a KStore computing environment in which adding and subtracting of KStores may be implemented. The computing environment may include one or more networked or unnetworked computers capable of implementing and processing KStores on which one or more of the following reside: a K Engine 14, one or more KStores such as KStore 12 and KStore 13, a Learn Engine 26, one or more data sources 30, a utility 16, an application programming interface (API) utility 23, one or more graphical user interfaces (e.g., GUI 38, GUI 36) and one or more applications such as application 34. One or more of: K Engine 14, Learn Engine 26, utility 16, application programming interface (API) 23, graphical user interfaces (e.g., GUI 38, GUI 36) and application 34 may be executed by the processor of a KStore computer.

The Learn Engine 26 may receive data from many types of input data sources and may transform the received data to particles suitable to the task to which the KStore being built will perform. For example, if the data being sent to the KStore is information from a field/record type database, particular field names may be kept, changed, or discarded, depending on the overall design of the KStore the user is creating. After breaking down the input into appropriate particles, the Learn Engine 26 may make appropriate calls to the K Engine 14 and pass the data in particle form in a way that enables the K Engine 14 to put it into the KStore structure,

API utilities such as API utility 23 receive inquiries and transform the received inquiries into calls to the K Engine, to access the KStore directly or to update associated memory. In the event that a query is not to be recorded in the structure of a KStore a LEARN SWITCH may be turned off. In the event that a query is to be recorded in the structure of the KStore, (as in Artificial Intelligence applications, for example) the LEARN SWITCH may be turned on. API utilities may get information from the KStore using predefined pointers that are set up when the KStore is built (rather than by transforming the input into particles and sending the particles to the KEngine). For instance, a field may point to the Record End of Thought (EOT) node, the Field EOT node, the Column EOT node and the Beginning Of Thought (BOT) node. This field may be associated with the K Engine, and may allow the K Engine to traverse the KStore using the pointers in the field without requiring the API Utility to track this pointer information.

Within the KStore computing environment information may flow bi-directionally between the KStore or KStores, a data source 30 and an application 34 by way of a K Engine 14. The transmission of information between the data source 30 and the K Engine 14 may be by way of a learn engine 26, and the transmission of information between the application 34 and the K Engine 14 may be by way of an API or API utility engine 23. Data source 30 and application 34 may be provided with graphical user interfaces 36, 38 to permit a user to communicate with the system.

Objects or other types of system components such as learn engine 26 and the API utility engine 23 may be provided to service learn and query threads so that applications and interfaces of any kind can address, build and use the KStore(s). Learn engine 26 may provide an ability to receive or get data in various forms from various sources on the same computer or on different computers connected via a network and to turn it into input particles that the K Engine 14 can use. The API Utility engine may provide for appropriate processing of inquiries received by application software of any kind. The API utility engine 23 and the learn engine 26 get information from and/or put information into a KStore. It will be understood by those of skill in the computer arts that software objects can be constructed that will configure the computer system to run in a manner so as to implement the attributes of the objects. It is also understood that the components described above may be created in hardware as well as software.

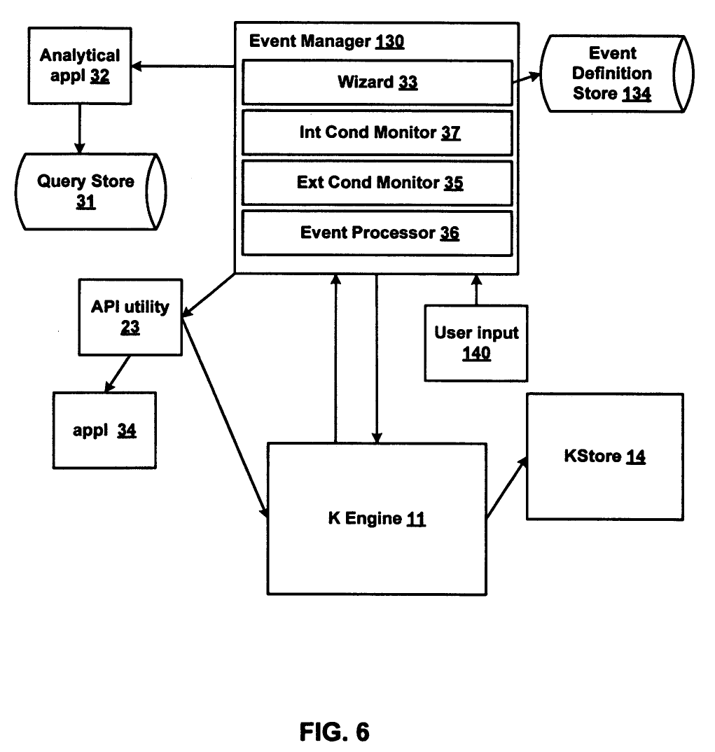

FIG. 6 is a block diagram of a system for automatic execution of one or more actions, events or sets of actions and events based on detected user-defined conditions in a KStore or user-defined KStore events in accordance with aspects of the subject matter disclosed herein. System 600 or portions thereof may reside on one or more networked or unnetworked computers capable of interacting with or hosting a KStore. System 600 may include one or more of the following components: a KStore 14, an event manager 33, an event store 134, an external condition monitor 35, a KStore condition monitor, analytical applications 32, an API utility 23, applications 34 such as a polling application, an event processor 36 and a query store 31. A KStore 14 or K is an interlocking trees data structure as described above. KStore 14 can be accessed by one or more K Engine(s) 11.

An applications software layer 15 may include various forms of GUIs (Graphical User Interfaces). One of the GUIs may be a GUI for an event manager that provides means for a user to define events that will be automatically performed when user-specified conditions are met. Parts of the event manager may reside on different computers and in different layers. For example, layer 15 may include data sources or programs that provide data to build a KStore 14, application programs that make queries of or provide data to to KStore 14. The components of layer 15 can be distributed across a network such as the Internet, LAN (local area network) or WAN (wide area network) or can be resident on the same computer which hosts KStore 14 and the K Engine 11, the Learn Engine (described above) and/or API Utilities.

Layer 16 may include at least one instance of API Utilities and/or a Learn Engine. Layer 16 may include the set of programs that enable calls for information or data input to address KStore 14. Calls to Layer 16 may initiate a thread that supplies a continuous or an intermittent stream of data to K Engine 11 or may include the parameters of a query for the API Utilities. The programs in layer 16 may set up a data storage area in memory to accommodate the processing needs of the thread.

Accordingly, an event manager 130 in accordance with some aspects of the subject matter disclosed herein comprises one or more of the following: an event wizard 33, an internal KStore event monitor (e.g., internal event monitor 37) and/or a KStore condition monitor 35) and an event processor 36. Events, actions (e.g., responses to conditions or events) or sequences of events and actions, triggering conditions for the events, actions or sequences of events and actions, and polling intervals for monitoring for triggering conditions may be stored in event definitions data store 134. KStore queries generated by analytic applications 32 from user input 140 provided to wizard 33 or collected in background by KStore Event Manager 130 may be stored in analytic queries data store 31. KStore queries generated by analytic applications 32 from user input 140 provided to wizard 33 or collected in background by KStore Event Manager 130 and stored in analytic queries data store 31 may determine if some or all of the triggering conditions have been met. Analytical application 32 may assemble KStore queries stored in analytic queries data store 31 according to a formal query grammar adapted to KStore. An external condition monitor 35 may monitor conditions or state of KStore or a portion thereof as described more fully below. An internal KStore event monitor 37 may monitor the KStore 14 to receive notifications from the KStore concerning events that have occurred. Event manager 130 may coordinate information received from external condition monitor 35, internal event monitor 37 and direct event processor 36 to execute events or perform responses as described above. Event manager 130 may also send notifications to a user to update event definitions stored in event definition data store 134 when an event, action or sequence of events and actions has been performed. Event processor 36 in response to a directive received from event manager 33 may execute the actions, events and sequences of actions and events stored in event definitions data store 134 when internal event have fired or specified KStore state has been attained.

User input 140 may be collected by the KStore Event Manager by running a background job that collects user input (e.g., parameters) from a user, from an application or from an existing well-defined set of user input. User input collected by the KStore Event Manager in background may specify an internal KStore event or events and responses thereto. Alternatively, an event wizard such as event wizard 33 may comprise a user interface such as a GUI (graphical user interface) that walks a user through the creation and/or updating of an internal KStore event or sequence or events and a response that will be performed when notification of the event occurring has been received by the event manager.

User input collected by the KStore Event Manager in background may specify an internal KStore condition, polling interval and response to attainment of the KStore condition. Alternatively, an event wizard such as event wizard 33 may comprise a user interface such as a GUI (graphical user interface) that walks a user through the creation and/or updating of conditions that trigger a response (an event, action or sequence of actions or events to be performed) and may include attainment of a specified internal KStore state. The wizard 33 may prompt the user for a polling interval for monitoring KStore state. The wizard 33 may also prompt a user for the number of times the event, action or sequence or events and actions is to be executed, when the event, action or sequence or events and actions is to be executed after the condition is reached and for any follow-up actions and when the follow-up actions are to be performed.

An event can be any action which can be initiated either by a user, a device (e.g., such as but not limited to a timer, keyboard, printer, etc.), a program or an operating system. When an event occurs (fires), data about the event is typically collected by a piece of hardware or software. The event collector may in turn send the information to an event handler for further processing. Alternatively, an event might be ignored or might be dispatched to multiple event handlers that are simultaneously listening for the event. Data associated with an event usually specifies at least what type of event has occurred and may include other information such as when the event occurred, who or what caused the event to occur, and other data provided by the event source to the handler about how the event should be processed.

Wizard 33 may prompt a user for a response to a notification that an event has occurred or that a specified condition has been attained. For example, an event that is performed as a response to receiving a notification that an event has occurred within KStore or that a condition within a KStore has been attained may be issuing a particular query to a KStore. A KStore query is a formal statement that specifies the values of particular nodes in a KStore by specifying a focus and one or more constraints. For example, a query to the KStore of FIG. 1 may specify a focus of “Bill-Tuesday” and a constraint of “count of node 104 (number of product 100 sold in PA on Tuesday”. Hence a provided focus determines a level of a KStore from which information is requested, and a particular branch of the asCase tree within the level from which information is to be ascertained. A constraint specifies what particular values are requested from the level and branch specified by the focus.

Another example of an response that may be executed is sending an email. Wizard 33 may prompt a user for input regarding one or more email recipients, what the header of the email to be sent will be, what the text of the email to be sent will be, whether the email is to be sent with high importance, low importance or regular importance, whether the email is to be flagged for follow-up, whether one or more attachments should be added to the email, and if so, specify the attachment(s) and their location, and so on. It will be appreciated that the examples presented herein are examples and are not meant to limit the scope of actions available and the information solicited by the wizard 33.

Wizard 33 may receive the user's input. Validation of the user's input may be performed iteratively. User input may be provided to analytic applications 32 to generate the queries required to access information in the KStore 14. The queries generated may be stored in analytic queries data store 31. When the response has been received, the wizard 33 may prompt the user for one or more conditions that trigger the response. Conditions may include one or more states of one or more nodes in a KStore 14 and/or logical combinations thereof For example a condition or combination of conditions may be:

“When count of Bill-(Monday+Tuesday)-sold is equal to or greater than 15”

“When count of Bill plus count of Tom is equal to or greater than 100”

“When count of Bill-Monday-100-trial-PA or count of Tom-PA is equal to or greater than 12”

Moreover a condition for a branch not currently in the KStore may be specified, for example:

“When count of Bill-(Monday+Tuesday+Wednesday+Thursday) is equal to or greater than 30” may be specified.

The wizard 33 may prompt the user for a polling interval for the KStore and/or specify a time at which the polling of the KStore is to start or resume. For example, the user may specify a polling interval of 5 seconds, or 3 days or any particular time interval at which the KStore is polled for the specified condition or combination of conditions. For example, if the polling interval is specified as 5 seconds, every 5 seconds, the KStore 14 is polled to see if the specified condition or combination of conditions threshold has been reached, starting immediately. If the polling interval is specified as every 3 days, the polling of the KStore 14 will take place every 3 days.

When a specified KStore event occurs, the internal event monitor 37 may notify event manager 130 that the internal event has occurred. External condition monitor 35 may monitor KStore state or conditions to determine when the specified condition or combination of conditions has been reached, by polling the KStore in accordance with the polling interval for the condition to be monitored for. When the condition or conditions is detected, external condition monitor 35 may notify event manager 130 that the specified condition has been detected. In accordance with the received information, the event manager 130 may direct event processor 36 to execute the event, or sequence events. The user may be then be notified of any follow-up actions. For example a user may be prompted to update or discontinue performance of the event, action or series of actions and events, and/or to modify the conditions that trigger performance of the event, action, or sequence of actions or events and/or to modify the associated polling interval(s).

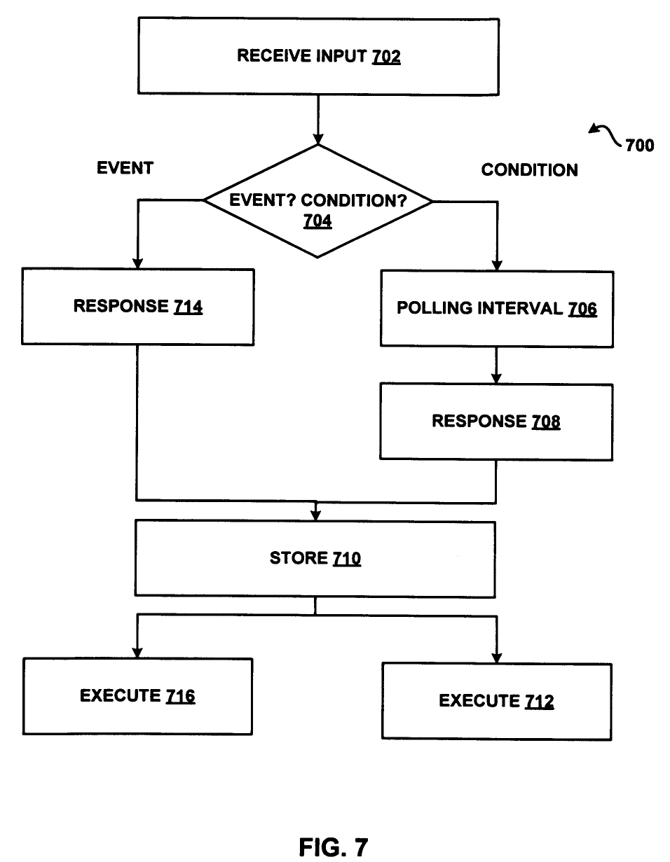

FIG. 7 illustrates a method 700 of for event management in a KStore in accordance with aspects of the subject matter disclosed herein. At 702 an event manager such as an event management wizard may prompt and/or receive user input. At 704 the user input is evaluated to determine if the user input is an internal KStore event for which a notification is to be sent to the event manager or if the user input is a KStore condition to be monitored for. At 706, in response to determining that the user input is a KStore condition to be monitored for, the user may be prompted for and the event manager may receive the polling interval. At 708 the response to attaining the condition may be prompted for and received. In response to receiving the response, at 710, the condition/polling interval/response may be stored in the event data store. At 712 in response to detecting that the condition has been attained by polling for KStore state, the response may be performed. If at 704 the user input is evaluated and it is determined that the user input is an internal KStore event for which a notification is to be sent to the event manager, the user may be prompted for and the event manager may receive a response to be performed upon receiving the notification at 714. At 710, the event/response may be stored in the event data store. At 716 in response to receiving the notification, the specified response may be performed.

The various techniques described herein may be implemented in connection with hardware or software or, where appropriate, with a combination of both. Thus, the methods and apparatus described herein, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing aspects of the subject matter disclosed herein. In the case of program code execution on programmable computers, the computing device will generally include a processor, a storage medium readable by the processor (including volatile and non-volatile memory and/or storage elements), at least one input device, and at least one output device. One or more programs that may utilize the creation and/or implementation of domain-specific programming models aspects, e.g., through the use of a data processing API or the like, may be implemented in a high level procedural or object oriented programming language to communicate with a computer system. However, the program(s) can be implemented in assembly or machine language, if desired. In any case, the language may be a compiled or interpreted language, and combined with hardware implementations.

While the subject matter disclosed herein has been described in connection with the figures, it is to be understood that modifications may be made to perform the same functions in different ways. While innumerable uses for this invention may be found, and significant variability in the form and manner of operation of this invention are described and will occur to those of skill in these arts, the invention is not limited in scope further than as set forth in the following claims.

What is claimed is:

1. A system for managing events in a KStore comprising:
an event manager comprising:
a wizard or background feature that receives or obtains
user input specifying a KStore state, a polling interval and a first action to be performed in response to detecting the specified KStore state or
user input specifying an internal KStore event and a second action to be performed in response to receiving a notification that the internal KStore event has occurred; and
an event processor that executes
the first action in response to detecting the specified KStore state or
the second action in response to receiving the notification that the internal KStore event has occurred, wherein the KStore comprises an interlocking trees datastore comprising elemental root nodes, subcomponent nodes and end product nodes linked by asCase and asResult bi-directional links that create asCase and asResult paths within the interlocking trees datastore, wherein an asCase path comprises a sequence of subcomponent nodes linked with bi-directional asCase links ending with an end product node and where each subcomponent node in the asCase path has a bi-directional asResult link to an elemental root node or end product node comprising an asResult tree.

2. The system of claim 1, wherein the KStore Event Manager directs a KStore API utility to direct a K Engine to send the notification to the KStore Event Manager when the specified internal KStore event occurs.

3. The system of claim 1, wherein the KStore Event Manager directs a KStore API utility to run a polling application to detect attainment of the specified KStore state.

4. The system of claim 1, further comprising:
an event store that stores the user-specified KStore state, the polling interval and the first action.

5. The system of claim 1, further comprising:
an event definition store that stores the user-specified internal KStore event and the second action.

6. The system of claim 1, wherein a response comprises an action, event, sequence of actions or sequence of events.

7. The system of claim 3, further comprising:
the polling application that polls the KStore based on the specified polling interval.

8. A method for managing events in a KStore comprising:
receiving user input, the user input comprising a response comprising an action, event, sequence of actions or sequence of events;
in response to determining that the user input further comprises a user-specified state to be monitored for in the KStore, prompting and receiving a polling interval at which the KStore is polled for the user-specified state and executing the response in response to detecting the user-specified state in the KStore; or
in response to determining that the user input further comprises a user-specified event, directing a K Engine to send a notification to an event manager, prompting for and receiving the user input comprising the response and executing the response in response to receiving the notification, wherein the KStore comprises an interlocking trees datastore comprising elemental root nodes, subcomponent nodes and end product nodes linked by asCase and asResult bi-directional links that create asCase and asResult paths within the interlocking trees datastore, wherein an asCase path comprises a sequence of subcomponent nodes linked with bi-directional asCase links ending with an end product node and where each subcomponent node in the asCase path has a bi-directional asResult link to an elemental root node or end product node comprising an asResult tree.

9. The method of claim 8, wherein the response comprises an action, event, sequence of actions or sequence of events.

10. The method of claim 8, wherein a polling application monitors the KStore for the specified state by periodically polling the KStore.

11. The method of claim 8, wherein the wizard collects the user input through a GUI interface.

12. The method of claim 8, wherein the user input is collected via a background job that collects the user input from an application or from an existing well-defined set of user input.

13. The method of claim 8, further comprising:
monitoring for the specified KStore state or for the specified KStore event via the KStore API.

14. A computer-readable medium comprising computer-executable instructions that when executed cause a computing environment to:
receive user input, the user input comprising a response comprising an action, event, sequence of actions or sequence of events;
in response to determining that the user input further comprises a user-specified state to be monitored for in the KStore, prompt for a polling interval at which the KStore is polled for the user-specified state, wherein the KStore comprises an interlocking trees datastore comprising elemental root nodes, subcomponent nodes and end product nodes linked by asCase and asResult bi-directional links that create asCase and asResult paths within the interlocking trees datastore, wherein an asCase path comprises a sequence of subcomponent nodes linked with bi-directional asCase links ending with an end product node and where each subcomponent node in the asCase path has a bi-directional asResult link to an elemental root node or end product node comprising an asResult tree.

15. The computer-readable medium of claim 14, comprising further computer-executable instructions that when executed cause the computing environment to:
receive the polling interval and direct a KStore API utility to run a polling application to poll the KStore.

16. The computer-readable medium of claim 15, comprising further computer-executable instructions that when executed cause the computing environment to:
execute the response in response to detecting the user-specified state in the KStore.

17. The computer-readable medium of claim 14, comprising further computer-executable instructions that when executed cause the computing environment to:
in response to determining that the user input further comprises a user-specified event, direct a K Engine to send a notification to an event manager.

18. The computer-readable medium of claim 17, comprising further computer-executable instructions that when executed cause the computing environment to:
prompt for and receive the user input comprising the response.

19. The computer-readable medium of claim 18, comprising further computer-executable instructions that when executed cause the computing environment to:
execute the response in response to receiving the notification.

20. The computer-readable medium of claim 14, comprising further computer-executable instructions that when executed cause the computing environment to:
receive the user input via a GUI interface or via a background job that collects existing user input.
